(19) United States
(12) Patent Application Publication
(10) Pub. No.: US 2009/0108635 A1
(43) Pub. Date: Apr. 30, 2009

(54) Roller Blind Arrangement With An Improved Guiding System

(76) Inventor: Bernhard Wingen, Feldkirchen (DE)

Correspondence Address: DICKINSON WRIGHT PLLC, 1875 Eye Street, NW, Suite 1200, WASHINGTON, DC, 20006, US

(21) Appl. No.: 11/994,178

(22) PCT Filed: Jun. 30, 2006
(86) PCT No.: PCT/DE2006/001138

§ 371 Date: Jul. 9, 2008

(30) Foreign Application Priority Data
Jul. 1, 2005 (DE) 10 2005 030 843.0

(51) Int. Cl. B60J 7/00

(52) U.S. Cl. 296/210

(57) ABSTRACT

The invention relates to a roller blind arrangement, especially for motor vehicles, for covering a roof opening (2), said arrangement comprising a roller blind strip (5) which can be wound up and down by means of a winding shaft (4). At least one deviating means (10) is used for influencing the course of the roller blind strip (5) in the direction of displacement thereof, the at least one deviating means (10) being arranged at a fixed distance from the winding shaft in the longitudinal direction of the vehicle.

The invention relates to a roller blind arrangement, in particular for motor vehicles, with an improved guiding system according to the preamble of claim 1.

DE 44 24 188 C1 discloses a roller blind arrangement for covering a transparent roof area of vehicles, in which a roller blind strip can be unwound from a winding shaft and wound up again by means of the winding shaft. The winding shaft is seated in a housing which is arranged underneath the outer skin of the roof behind the head region of a passenger in the passenger compartment of the vehicle. A supporting bow which runs across the transverse direction of the vehicle is displaceably coupled to the housing by means of pivoting levers parallel to the winding shaft. The supporting bow has the function of bringing about deflection of the roller blind strip in order to ensure sufficient headroom for vehicle occupants. It is necessary for the deflection bow to be coupled mechanically so as to be displaceable in parallel in order to permit the roller blind strip to be retracted completely. In this roller blind arrangement it is disadvantageous that the mechanical coupling of the deflection bow is complicated and in addition in the extended state can be seen by the vehicle occupants.

DE 102 44 156 A1 discloses a sunshade for a motor vehicle in which a first roller blind section can be wound up in a housing. At the free end of the first roller blind section a roller blind cartridge which contains a second roller blind section is seated. The cartridge can be extended over a certain length in the longitudinal direction of the vehicle in longitudinal guides on the roof struts. Starting from an extended end position of the cartridge, the second roller hind section can be extended out of the cartridge and serve as a windshield shade. This sunshade has the disadvantage that the necessary headroom for the vehicle occupants cannot always be ensured.

The object of the invention is to specify a roller blind arrangement with an improved guiding system in which, on the one hand, sufficient headroom is ensured for the vehicle occupants. On the other hand, a simple structure is to be specified which, in addition, cannot be seen by the vehicle occupants. A further object consists in the fact that the risk of injury to the vehicle occupant in the event of an accident is to be minimized.

This object is achieved with a roller blind arrangement with an improved guiding system having the features of claim 1. Advantageous embodiments are specified in the subclaims.

The invention will be explained below in more detail by way of example with reference to the drawing, in which:

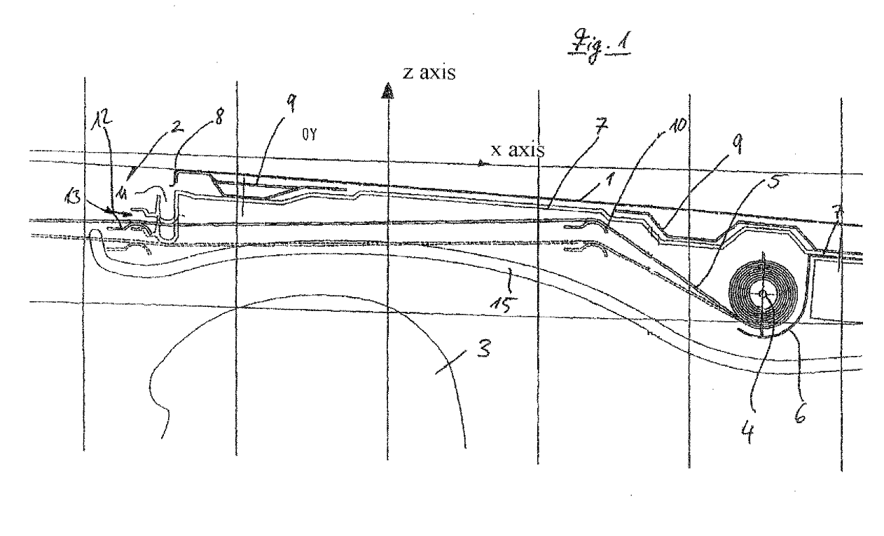

FIG. 1 shows a schematic view of a section through the roller blind arrangement according to the invention in a longitudinal center plane of the vehicle (X-Z plane where Y=0); and

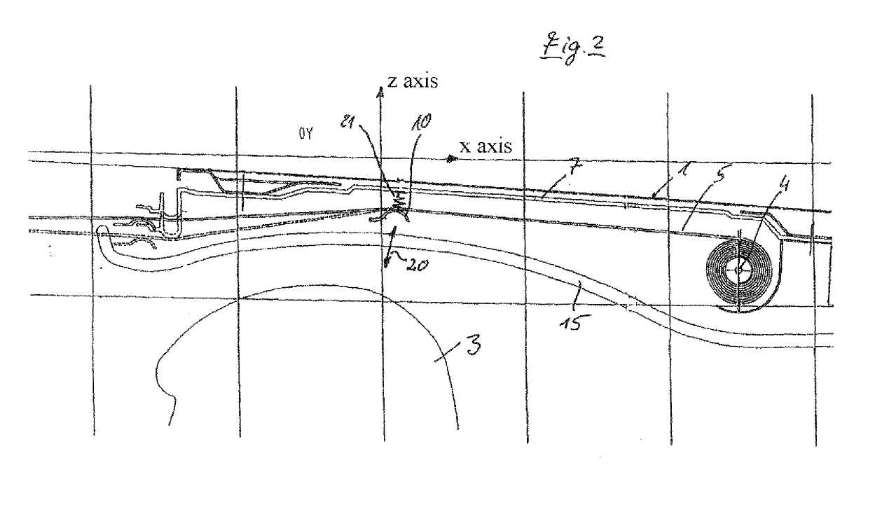

FIG. 2 shows a second embodiment of the roller blind arrangement according to the invention in a sectional illustration in the longitudinal center plane of the vehicle (X-Z plane where Y=0).

For the following description, the current vehicle coordinate system with a Z axis is defined as the vertical axis of the vehicle, an X axis is defined as the longitudinal axis of the vehicle and a Y axis is defined as the transverse axis of the vehicle. In the illustrated detail from the figures, the positive direction of the X axis points towards the rear in the longitudinal direction of the vehicle.

A roof skin 1 of a vehicle has a roof opening 2, which can be closed off with a sunroof insert (not shown). A vehicle occupant 3, who is seated, for example, on the rear seat bench, is located in the longitudinal direction of the vehicle with his head behind the roof opening 2 underneath a closed roof skin region. Behind the vehicle occupant 3 in the longitudinal direction of the vehicle, a winding shaft 4, on which a roller blind strip 5 is wound up in such a way that it can be unwound, in particular that it can be unwound and wound up in a drivable fashion, runs in the transverse direction of the vehicle. The winding shaft 4 is seated in a bearing housing 6 in which the latter is rotatably mounted. The bearing housing 6 is connected to a carrier module 7. The carrier module 7 extends from a region somewhat behind the winding shaft 4 as far as approximately a rear end 8 of the roof opening 2. The carrier module 7 is connected to the shell of the vehicle body at suitable locations, for example to transverse beams 8 of the roof.

The roller blind strip 5 can be extended forward in the longitudinal direction of the vehicle (in the negative X direction) to such an extent that the entire roof opening can preferably be shaded entirely.

In the illustrated exemplary embodiment according to FIG. 1, the winding of the roller blind strip 5 on the winding shaft 4 is carried out in such a way that the roller blind strip is unwound from the lower region of the winding shaft 4. In the illustrated exemplary embodiment, this is done for reasons of freedom of movement of the roller blind strap with respect to one of the roof bows 9 of the shell of the vehicle body. In order to ensure sufficient headroom for the vehicle occupant 3, the invention proposes providing at least one deflection bow 10. The deflection bow 10 extends in the transverse direction of the vehicle, preferably in a bowed fashion so as to follow the curvature of the roof skin 1. In the sectional illustration according to FIG. 1, the deflection bow 10 is thus arranged higher in the sectional plane at Y=0 (=longitudinal center plane of the vehicle) in the direction in the Z axis of the vehicle (unbroken line in FIG. 1) than in an outer region of the vehicle closer to the roof struts of the vehicle (dashed illustration in FIG. 1) running laterally in the longitudinal direction of the vehicle. In the embodiment according to FIG. 1, the deflection bow 10 is arranged in the longitudinal direction of the vehicle in a region between the vehicle occupant and the winding shaft 4 in such a way that the roller blind strip 5 is deflected upward sufficiently so that sufficient headroom of the vehicle occupant 3 is ensured. The deflection bow 10 is fixedly arranged in a non-displaceable fashion in the installation state in the longitudinal direction of the vehicle with respect to the vehicle body and/or with respect to the carrier module 7. The deflection bow 10 is for this purpose mounted at suitable locations in the carrier module 7 or attached to suitable locations on the roof side struts of the shell of the vehicle body. The deflection bow 10 is embodied, for example, as a sliding bow with an arcuate cross-sectional contour over which the roller blind strip is guided in a sliding fashion.

According to one preferred embodiment, the deflection bow 10 can also be embodied as a rotatably mounted, bendable roller in order to reduce the sliding resistance of the roller blind through rolling friction. It is also suitable to form the deflection bow 10 from a plurality of rollers which are barrel-shaped in the longitudinal section and which are arranged on a bendable or bent axis.

At the front free end of the carrier module 7, for example, a water-collecting profile 11 with a U-shaped cross section is formed on, said water-collecting profile 11 being arranged, when the sunroof is opened, approximately below the rear end 8 of the roof opening 2 and therefore being able to collect flowing-off water. The arcuate, lower region of the water-collecting profile 11 which points towards the interior of the vehicle can advantageously be embodied as a guide face for the roller blind strip 5 on its side facing the roof skin 1.

In order to guide the roller blind strip 5 in a defined fashion in the region of the front end of the carrier module 7, a further deflection bow 12 is preferably seated in front of the water-collecting profile 11 in the direction of the vehicle. The deflection bow 12 forms, together with the inside of the arcuate wall of the water-collecting profile 11, a mouth slot 13 for the roller blind strip 5.

The roller blind arrangement as described above is visually covered on the underside by an inner roof lining 15.

In a second embodiment of the roller blind arrangement according to the invention (FIG. 2), the roller blind strip 5 can be unwound from the winding shaft 4 on its upper side since a corresponding free passage is provided to the surrounding components (missing transverse bow 9 of the roof here). As a result, the roller blind strip runs starting from the winding shaft closer to the roof skin 1. In order to ensure sufficient headroom for the vehicle occupant 3, the deflection bow 10 is arranged, for example, in the region above the head of the vehicle occupant 3 in such an embodiment. For the rest, the design of the exemplary embodiment according to FIG. 2 corresponds to the design of the exemplary embodiment according to FIG. 1 as described above.

According to a further embodiment (not shown), the profile of the roller blind strip 5 in the longitudinal direction of the vehicle can, of course, also be influenced in a desired fashion by a plurality of deflection bows 10.

According to a further advantageous embodiment, the deflection bow 10 and/or the deflection bow 12 are mounted so as to be displaceable in relation to the carrier module 7 or in relation to the body of the vehicle in a deflection direction 20, in particular mounted with sprung prestress. This has the advantage that during an accident, during which the head of the vehicle occupant 3 may strike against the inner roof lining 15 in the region of the deflection bow 10, the latter is not pushed through the inner roof lining 1S constituting a risk of injury for the vehicle occupant. The direction of the deflection direction 20 is advantageously selected here in terms of its inclination in such a way that, in the impact direction of the vehicle occupant 3 which is expected with the highest level of probability, the deflection bow 10 can easily be deflected on the inner roof lining 15 in an accident model which is, for example, idealized. As an alternative to the sprung bearing at the ends of the deflection bows 10, the deflection bow 10 can also be elastically bendable in a sprung fashion so that in the case of an accident deflection of the deflection bow 10 is made possible. The sprung bearing of the deflection bow 10 in the deflection direction 20 is represented schematically in FIG. 2 by a compression spring 21. The compression spring 21; is supported at one end on the carrier module 7 and at the other end on the ends of the deflection bow 10.

According to a further preferred embodiment, the roller blind arrangement has on the underside a module lid (not shown) which corresponds to the carrier module 7 and forms, together with the carrier module 7, a cartridge for the roller blind arrangement. In this embodiment, it is particularly advantageous to integrate deflection surfaces of the deflection bows 10 in the cassette lid on the underside as sliding surfaces. In this case, the deflection bows 10 and, if appropriate, 12 can be dispensed with as individual parts. Their function is performed by the cartridge lid on the underside.

According to a further embodiment, the deflection bow 10 and/or the deflection face of the cartridge lid is of straight design in the transverse direction of the vehicle. This is appropriate, in particular, if, in the region of the necessary headroom of the vehicle occupant 3, the inner roof lining 15 has a straight profile in the transverse direction of the vehicle. Through the selection of the spatial shape of the deflection bow 10 in its longitudinal extent and through the selection of the spatial shape of the sliding surface in the cassette lid it is therefore easily possible to achieve an optimum roller blind profile for ensuring the necessary headroom for the vehicle occupant 3.

In the roller blind arrangement according to the invention, it is particularly advantageous that the roller blind winding shaft 4 can be placed behind the headroom of the vehicle occupant 3. Through the simple position, defined essentially in the longitudinal direction of the vehicle, of one or more deflection bows 10 it is possible to adapt the guiding system in an optimal way to the installation space conditions and the space requirement of the vehicle occupant 3. A mechanically complicated connection of a displaceable deflection bow according to the prior art can be dispensed with. Furthermore, it is easily ensured that the risk of injury in the case of an accident is minimized.

### LIST OF REFERENCE NUMERALS

1 Roof skin
2 Roof opening
3 Vehicle occupant
4 Winding shaft
5 Roller blind strip
6 Bearing housing
7 Carrier module
8 Rear end
9 Roof bow
10 Deflection bow
11 Water-collecting channel
12 Further deflection means
13 Mouth slot
15 Inner roof lining
20 Deflection direction
21 Compression spring

1. A roller blind arrangement, in particular for motor vehicles, for covering a roof opening, said
arrangement comprising a roller blind strip which can be wound up and unwound by means of a winding shaft, wherein at least one deflection means is provided for influencing the course of the roller blind strip in the direction of extension thereof, characterized in that the at least one deflection means is arranged at a fixed distance from the winding shaft in the longitudinal direction of the vehicle.

2. The roller blind arrangement of claim 1, characterized in that the at least one deflection means is a deflection bow.

3. The roller blind arrangement of claim 1, characterized in that the at least one deflection means is a deflection surface, wherein the deflection surface is integrated into a roller blind module housing part.

4. The roller blind arrangement of claim 1, characterized in that the deflection bow is embodied as a deflection roller, in particular as a bendable deflection roller, or is formed from a plurality of deflection rollers on a bendable or bent axis.

5. The roller blind arrangement of claim 1, characterized in that the deflection roller has a spatial shape which is barrel-shaped in the longitudinal section.

6. The roller blind arrangement of claim 1, characterized in that the at least one deflection bow is displaceably mounted in a deflection direction.

7. The roller blind arrangement of claim 1, characterized in that the roller blind arrangement has a carrier module by means of which the roller blind arrangement can be mounted as a module in the region of a roof underside of a roof skin of a vehicle.

8. The roller blind arrangement of claim 1, characterized in that the carrier module extends from a region behind a head of a vehicle occupant as far as a rear end of a roof opening and has a water-collecting profile in the region of the rear end of the roof opening.

9. The roller blind arrangement of claim 1, characterized in that in the region of the water-collecting profile there is at least one further deflection means which forms, together with the water-collecting profile, a mouth slot for the roller blind strip.

10. The roller blind arrangement of claim 1, characterized in that the roller blind arrangement is visually covered by means of an inner roof lining.

11. The roller blind arrangement of claim 1, characterized in that the winding shaft is arranged in a bearing housing which is connected to the carrier module.

12. The roller blind arrangement of claim 1, characterized in that the deflection means is formed in the region of the inner roof lining a transverse direction of the vehicle, essentially parallel to the contour of said inner roof lining.

13. The roller blind arrangement of claim 1, characterized in that the at least one deflection means is displaceably mounted under sprung prestress in the deflection direction.

14. The roller blind arrangement of claim 1, characterized in that there is a carrier module lid part which, together with the carrier module, forms a module housing.

15. The roller blind arrangement of claim 1, characterized in that the deflection means corresponds in its longitudinal profile to the contour of the profile of the inner roof lining.

16. The roller blind arrangement of claim 1, characterized in that the deflection bow is of elastically bendable design.
